(19) United States
(12) Patent Application Publication
(10) Pub. No.: US 2010/0218496 A1
(43) Pub. Date: Sep. 2, 2010

(54) PASSIVE HEAT ENGINE SYSTEMS AND COMPONENTS

(76) Inventor: Mark W. Miles, San Francisco, CA (US)

Correspondence Address: HAHN AND MOODLEY, LLP, 548 Market Street, San Francisco, CA, 94104, US

(21) Appl. No.: 12/396,336

(22) Filed: Mar. 2, 2009

(51) Int. Cl. F02G 1/053

(52) U.S. Cl. 60/517; 62/6; 60/519; 60/530

(57) ABSTRACT

Methods for harnessing a heat source to produce energy are provided. One method comprises transferring heat from the heat source to a working fluid using at least one heat pipe; and performing work via the heated working fluid. Another method comprises operating a thermodynamic cycle to convert heat into work, comprising displacing a working fluid within a closed loop, said closed loop being defined by a first pathway within a working chamber, and a return pathway external to the return chamber; wherein displacement of the working fluid along the first pathway causes sympathetic displaced of a movable member held captive in the working chamber, and displacement of the working fluid along the external pathway is under influence of capillary forces; and transferring heat to the working fluid using at least one first heat pipe. Components and systems for implementing the methods are also provided.

### FIELD

Embodiments of the present invention relate to heat engine systems.

### BACKGROUND

FIG. 1 is a schematic illustration of a heat engine system which is supplied with heat from generic source 100. Generic heat source 100 represents a variety of heat sources including but not limited to sources 102, 104, and 106, representing solar, combustion, and geothermal sources, respectively. In one embodiment, pump 110 extracts heat from the source by pumping a heat transfer fluid (such as water) through piping system 111. The heat is transferred via heat exchanger 112, to a working fluid (such as water, a refrigerant, or other liquid medium) which is circulated via pump 114 via working fluid piping system 115.

The working fluid is heated in the heat exchanger and is consequently turned into a vapor which drives turbine 116. Turbine 116 is mechanically connected to electric generator 118, resulting in the production of electricity. Heat exchanger 120 serves to cool the working fluid so that it condenses and can be re-heated. The loop comprising heat exchangers 112, 120, and turbine 116 is referred to as a Rankine Cycle, or Organic Rankine Cycle if the working fluid is a liquid other than water. Pump 121 circulates another heat transfer fluid via piping system 122, through absorption chiller 124, and heat rejector 126. Absorption chiller 124 uses processes that are well known by those skilled in the art, to convert some of the rejected heat into a cooled liquid medium. Heat rejector 126 serves to get rid of the remaining waste heat, and thus provide a means to cool and therefore condense the working fluid in pipe system 115. Heat storage vessel 108, provides a means for storing excess thermal energy for later use.

There are many inefficiencies and shortcomings inherent within the above-described heat engine system, including:

Parasitic losses in the form of power required by pumps to circulate heat transfer fluids within a piping system.

High maintenance costs of heat transfer pumps and systems.

Heat losses from the piping system via conduction, convection, and radiation.

Inefficient extraction of heat from the various sources.

Heat losses from the heat extraction components.

Excessive size of heat exchange units due to inefficient heat exchangers.

Excessive size of heat rejection unit due to inefficient heat exchangers.

Inefficiencies in the transfer of heat to and from the working fluid.

Negative environmental impacts associated with extracting and rejecting heat to and from natural sources.

High cost and complexity of systems to extract and reject heat to and from environmental sources.

### SUMMARY OF THE INVENTION

In accordance with one embodiment of the invention there is provided a method for harnessing a heat source to produce energy, comprising: transferring heat from the heat source to a working fluid using at least one heat pipe; and performing work via the heated working fluid.

In accordance with a second embodiment of the invention, there is provided a method for harnessing a heat source to produce energy, comprising: operating a thermodynamic cycle to convert heat into work, comprising displacing a working fluid within a closed loop, said closed loop being defined by a first pathway within a working chamber, and a return pathway external to the return chamber; wherein displacement of the working fluid along the first pathway causes sympathetic displaced of a movable member held captive in the working chamber, and displacement of the working fluid along the external pathway is under influence of capillary forces; and transferring heat to the working fluid using at least one first heat pipe.

In accordance with a third embodiment of the invention, there is provided a method for harnessing a heat source to produce energy, comprising: operating a thermodynamic cycle in which a working fluid is circulated within a closed loop to perform work; and exchanging heat with the working fluid using modulatable heat pipes.

In accordance with a fourth embodiment of the invention, there is provided a system for producing energy from a heat source, comprising: a heat engine; and at least one heat pipe coupled to the heat engine to exchange heat with a working fluid of the heat engine.

In accordance with a fifth embodiment of the invention, there is provided a heat engine system, comprising: a heat engine, comprising a working fluid circulating within a closed loop; at least one heat exchange device comprising a two-phase heat transfer fluid; and a control unit to control operation of the heat exchange device.

Other embodiments of the invention will be apparent from the detailed description below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a schematic representation of a heat engine system.

FIG. 2 shows an illustration of operation of cylindrical and planar heat pipe designs.

FIG. 3 shows several heat pipe configurations, in accordance with different embodiment s of the invention.

FIG. 4 illustrates of a heat pipe heat exchanger, in accordance with one embodiment of the invention.

FIG. 5 shows a schematic representation of an improved heat engine system, in accordance with one embodiment of the invention.

FIG. 6a shows an example of prior art for an evacuated tube solar collector.

FIG. 6b shows a schematic representation of a solar tube absorber, in accordance with one embodiment of the invention.

FIG. 6c shows a configuration for a solar tube array, in accordance with one embodiment of the invention.

FIG. 7 of illustrates the function of an evacuated flat plate solar collector, and a planar collector concentrator module, in accordance with one embodiment of the invention.

FIG. 8 shows an evacuated flat plate collector interfaced to a heat pipe heat exchanger, in accordance with one embodiment of the invention.

FIG. 9 illustrates several heat pipe configurations for convective heat exchange.

FIG. 10 shows a heat pipe and heat exchanger, in accordance with one embodiment of the invention, configured to extract heat from a geothermal source.

FIG. 11 shows a heat pipe interfaced to a thermal storage unit.

FIG. 12 is a schematic representation of a heat engine system, in accordance with one embodiment of the invention, with additional improvements.

FIG. 13 illustrates several apparatus and techniques for rejecting heat, in accordance with embodiments of the invention.

FIG. 14 s shows a schematic representation of a heat engine system, in accordance with another embodiment of the invention.

FIG. 15 shows a steam heat engine, in accordance with one embodiment of the invention, incorporating heat pipes.

FIG. 16 shows a schematic representation of a heat engine system incorporating a steam heat engine, in accordance with one embodiment of the invention.

FIG. 17 shows a schematic representation of a heat engine system, in accordance with one embodiment of the invention, incorporating a control system.

FIG. 18 shows several configurations for a radiative waveguide component, in accordance with embodiments of the invention.

FIG. 19 shows a radiative waveguide array, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In one embodiment, heat pipes are uses in a heat engine system to transfer heat from one point to another, without the overhead of parasitic pumping losses, as will be described.

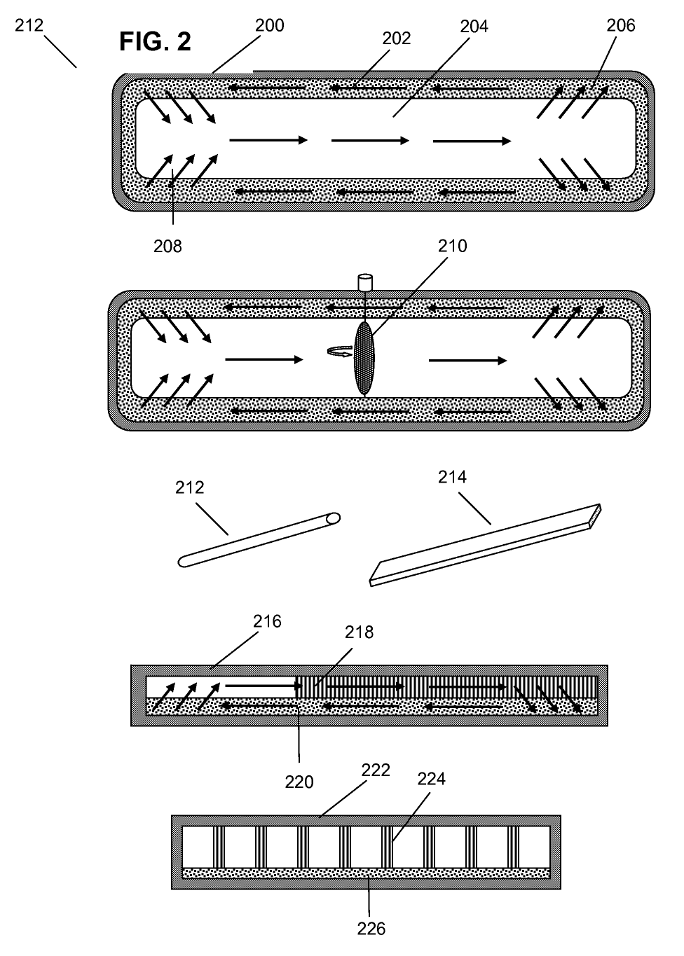

Referring to FIG. 2, there is shown a cross-section through an embodiment of a heat pipe. As will be seen, the heat pipe includes a heat pipe shell 200 which has an inner wick lining 202 that allows a heat transfer fluid e.g. water to move via surface tension forces in the direction of the arrows indicated within the wick 202. The wick may comprise an array of microscopic grooves, a sintered metal layer, a fibrous layer, or other material. The water travels to a heated end of the heat pipe where it is evaporated, thereby transferring heat into water vapor 208. Water vapor, traveling in the direction of arrows 204, is forced by pressure to propagate at sonic speeds to the end of the heat pipe remote from the heated end, where is condenses on the wick at 206, and is recirculated. The water vapor may condense at any location within the heat pipe which is colder than another portion of the pipe. Since heat pipes can work in both directions they tend to keep the temperature uniform throughout the heat pipe. Thus they can both heat and cool different locations depending on the temperature difference between those locations. The heat pipe has no parasitic losses because no external pumping is required to move the condensed liquid as capillary forces within the wick perform this function. If there is some external pumping utilized instead of or in addition to capillary forces, then the amount of liquid to be pumped is significantly smaller since the vast majority of the heat is carried in the vapor which absorbs much more heat than the liquid state of the same heat transfer fluid.

In one embodiment, the heat pipe may include a control mechanism to modulate the flow of heat within the pipe. The control mechanism may comprise a thermal valve 210 in the form of a rotatable circular plate which, depending on its position, allows, impedes, or obstructs the flow of vapor in the pipe thus effectively providing a means for modulating heat flow within the pipe. In another embodiment (not shown), the control mechanism may involve changing the internal volume of heat pipe. One example is described in the document VCHP.pdf which is hereby incorporated by reference. It should also be noted that the use of an external pump provides another means for modulating heat flow within the heat pipe.

Heat pipes of the kind just described may be fabricated in a variety of shapes and sizes. Cylindrical and flat heat pipes 212 and 214 are shown for comparison. Heat pipe 216 shown in cross-section is flat. In heat pipe 216 heated vapor 218 flows to the right, and cooled fluid 220 flows to the left.

In heat pipe 222, which is shown in a cross-section, vapor flows into and out of the plane of the page. Internal supports 224 serve to provide structural support for the external surfaces. Using micromachining and related techniques these internal supports may be manufactured on a microscopic scale with lateral dimensions on the order 10's of microns. This allows for the surfaces and material interfaces i.e. the thickness of the heat pipe wall, to be extremely thin, possibly on the order of 10's or 100's of microns because a great deal of mechanical support can be provided without significantly impeding liquid and vapor flows. Thermal resistance is in part determined by the thickness of the heat pipe wall material through which heat is conducted. By utilizing such thin metals in construction (compared to 2 mm or 2000 microns for typical heat pipe tubing) efficiency improvements of up to 2 orders of magnitude are possible, thereby reducing the size and weight of heat exchangers incorporating such devices. Materials including but not limited to metallic oxides, nitrides, or alloys of these materials with metals, may also be used in the construction of these walls. The overall heat pipe component can be largely fabricated using micromachining techniques commonly applied to fabricating micro-fluidic or other MEMS devices, and well known to those skilled in the art.

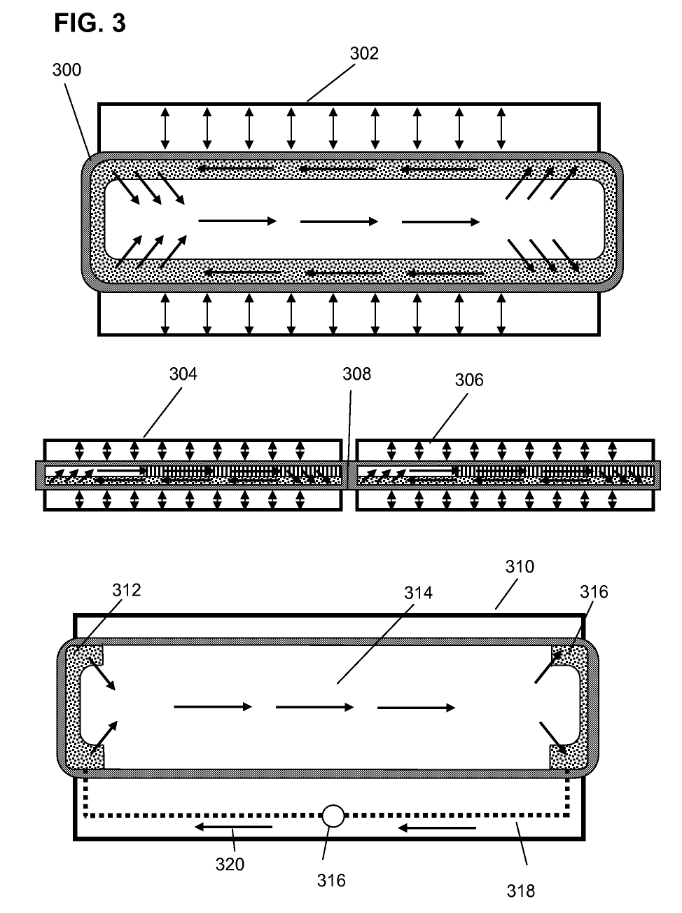

FIG. 3 illustrates a heat pipe 300, which has been insulated by virtue of external shell 302. In one embodiment, shell 302 may comprise materials such as metals, glass, or suitably coated plastics, which prevent the permeation of gasses. In accordance with different embodiments, the space between the shell 302, and the heat pipe 300, can be either a vacuum, or a material with low thermal conductivity. Incorporating such an improvement minimizes the heat lost or gained from external sources as the heat transfer vapor propagates through the pipe. As the length of a heat pipe increases, the amount of heat it can transfer is reduced in inverse proportion to its length. Additionally if the heat pipe is in a vertical orientation, or it is too long then the forces of gravity overcome the capillary forces. In one embodiment, these constraints are effectively overcome by joining one or more heat pipes.

Referring again to FIG. 3, heat pipe 304 is shown thermally joined to heat pipe 306. Normally, physically coupling two heat pipes would result in a significant drop in performance as the heat transfer from vapor, to the solid material of the heat pipe shell, back to vapor again is very inefficient compared to the heat transfer of the vapor stream. In one embodiment, to counter this drop in performance, the material thickness of the shell at the join is extremely thin (of order less than 500 microns) and the surfaces are in intimate contact. The latter constraint requires that the surfaces be sufficiently smooth, or that a filler material (with thickness of order less than 500 microns) be present to provide contact over the majority of the material interface area.

Alternatively, in one embodiment, a heat pipe may be effectively lengthened by using an external pump to move the condensed fluid as shown in insulated heat pipe 310. In this case evaporator wick 312 emits vapor stream 314 which propagates and condenses on wick 316. The condensed fluid is subsequently pumped via pipe 318 using pump 322, in the direction of arrow 320. While this configuration is not as efficient, it still requires less parasitic power than if the heat were entirely transferred in liquid form.

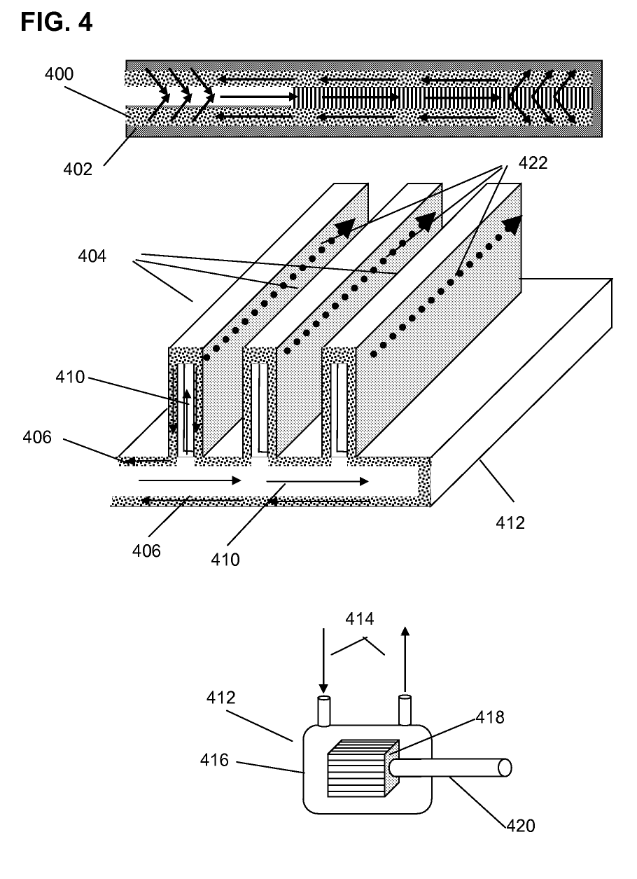

FIG. 4 shows a schematic of a heat pipe heat exchanger, in accordance with one embodiment. Planar heat pipe fin 400 is shown in cross-section with one open end. The shell of the heat pipe fin 402 is on the order of 10's-100's of microns thick. Heat fin section 412, comprises an array of heat pipe fins 404, all of which are physically connected. Hot vapor flow 410 propagates into the fins where it deposits heat, and condenses on the wicking material that resides on all internal surfaces. The wick then pumps the condensed water 406 out of the section.

Heat exchanger 416 is an air tight vessel containing a heat transfer fluid (water, refrigerant, or other fluid) with fluid flow into and out of the exchanger illustrated by arrows 414. Heat fin block 418, is suspended in the middle of the exchanger and completely immersed in the heat transfer fluid. Heat fin block 418 is comprised of multiple heat fin sections 412, which are physically connected such that internal vapor and heat transfer fluid transfer occurs through heat pipe 420. There is no physical contact between the fluids and vapors within the heat fin block, and the heat transfer fluid within the heat exchanger. Heat transfer through a material is inversely proportional to the thickness of the material. Because the material interface between the heat fin block and the heat transfer fluid is on the order of 10's-100's of microns thick, heat transfer through the medium is very efficient, and the overall size of the heat exchanger can be significantly reduced compared to conventional shell and tube heat exchangers which rely on interface materials which are at least 1 mm (1000 microns) thick.

Additional improvements in performance can be achieved by controlling the spacing between the individual fins 404. Arrows 422 represent fluid flow between the fins, and it is into this fluid that heat from within the fins is to be injected or, conversely, extracted from the fluid. If spacing between the fins is kept below about 2 mm, then the net heat transfer coefficient of the moving fluid is increased based on thermodynamic theory. Such a heat transfer structure can be referred to as a micro channel array, and it allows the length of the fins to be shorter while maintaining the same amount of heat transfer. The smaller spacing also encourages laminar flow (vs. turbulent flow) that has the net result of reducing the amount of energy required to pump the fluid between the fins, thus reducing parasitic pumping losses.

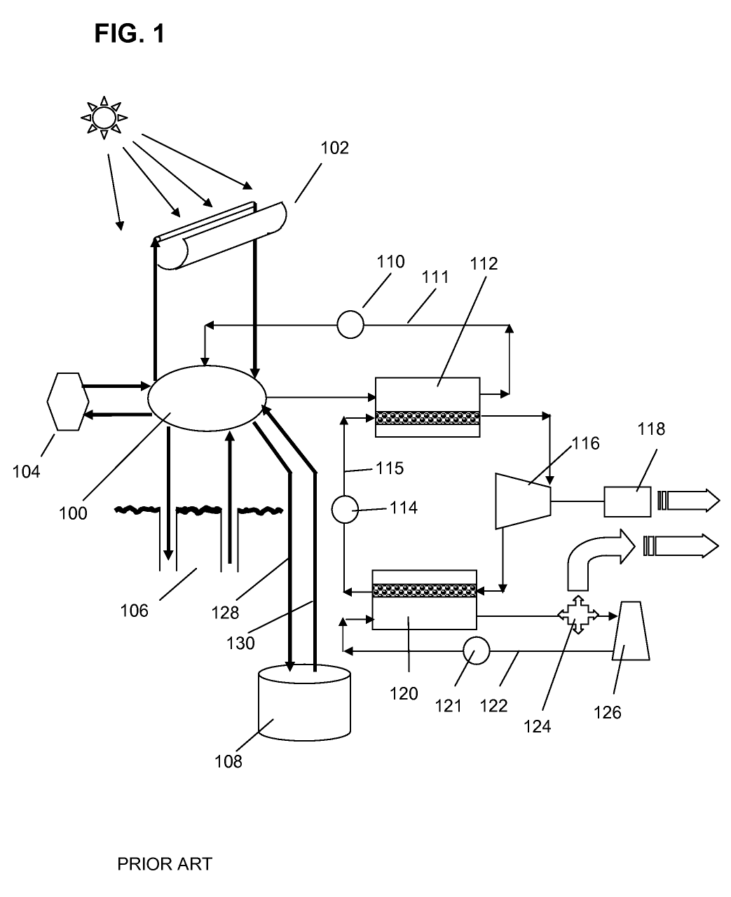

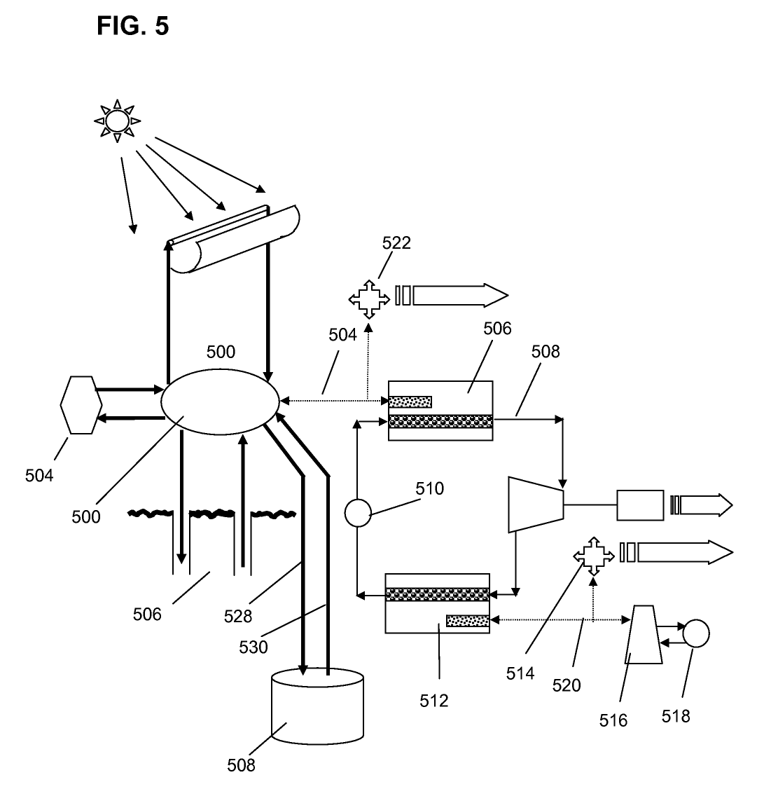

The components envisioned in FIGS. 2, 3, and 4 allow for improvements in the overall heat engine system that are now shown in FIG. 5. In particular, heat transfer between generic heat source 500 and heat exchanger 506, and heat transfer between heat rejector 516, absorption chiller 514 and heat exchanger 512 all occur via heat pipes 504 and 520, respectively. The pumping loops that existed before, shown in FIG. 1, are eliminated reducing parasitic pumping losses. There are still some pumping losses from heat rejector pump 518, but these are smaller, and can be eliminated with additional modifications. There is also additional flexibility in configuring the system. For example in some configurations it may be advantageous to connect the absorption chiller 514 directly to the heat source as shown by alternative absorption chiller 522.

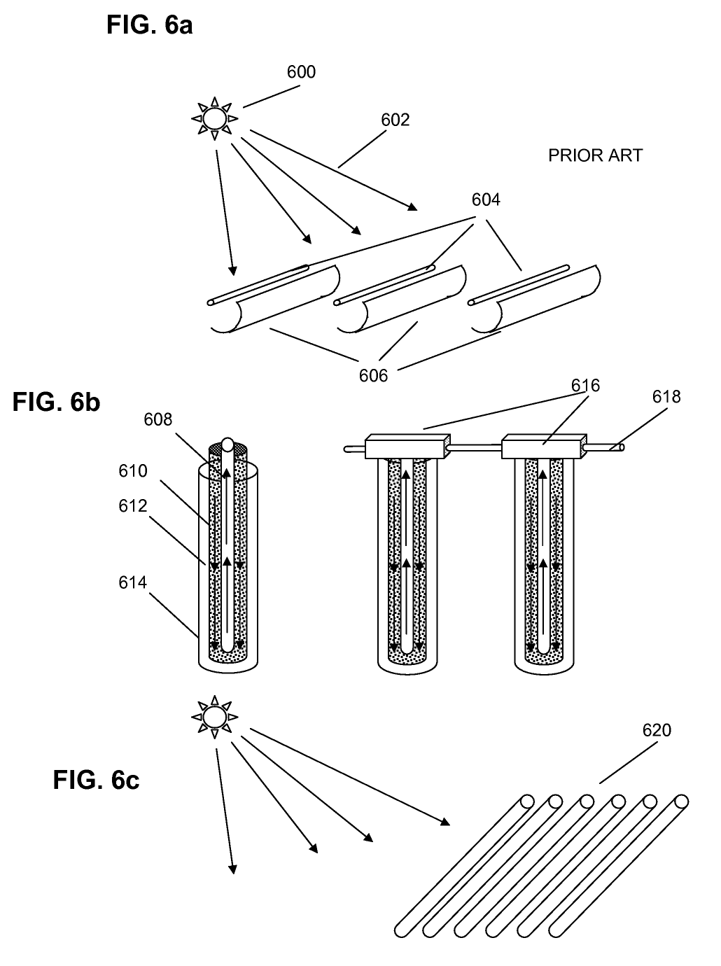

FIG. 6a describes prior art and illustrates one means for extracting heat from solar radiation. The sun 600 emits radiation in both visible and infrared regions that is incident on parabolic trough reflector array 606. The reflector array concentrates the sunlight so that it is absorbed by the heat transfer tubes 604, located at the focal points of each reflector. A heat transfer fluid is pumped through the tubes thus providing a means for extracting heat. The nature of this approach is such that the reflector and heat transfer tubes must be rotated throughout the day to track the position of the sun thus keeping the focal point located on the heat transfer tube. This adds complexity to the system due to the mechanisms and electronics which provide the tracking, though it can provide very high temperature fluids.

Comparable thermal performance may be achieved by utilizing a solar tube absorber, also prior art, which is shown in FIG. 6b, in accordance with one embodiment. The solar tube absorber comprises a transparent outer shell 614, and a heat pipe 612 which has a solar absorbing coating on its exterior to absorb incident solar radiation. A vacuum exists between the heat pipe and the external shell, thus none of the heat absorbed by the heat pipe from incident solar energy can be lost through conduction to the shell. However, heat can be lost via radiation from the heat pipe through the outer shell. Heat is extracted from the heat pipe via vapor 608, and condensed heat transfer fluid is pumped back into the heat pipe via wick 610 in a fashion described previously. A plurality of solar tube absorbers may be thermally connected via conventional fluid bearing pipe 618, which transfers heat between thermal interfaces 616. These interfaces are usually machined copper blocks or plugs which are in direct physical contact with the heat transfer vapor/fluid within the solar tube in a way which does not allow the vacuum to be compromised.

Solar tube array 620 allows radiation from the sun to be converted into hot water for domestic use. The advantage of a solar tube array is that it does not have to track the sun as the incident radiation from the sun strikes the tubes from many angles. The disadvantage is that many tubes are required per area of light intercepted and the active area of the array, the percentage of light which can be intercepted, is degraded by the spacing between the tubes, and the spacing between the shell and the heat pipes within.

In general, many aspects of this invention and the components described herein incorporate coatings of materials which can be deposited in a variety of ways (spun on, sputtered, evaporated, etc.) which are well known by those skilled in the art. These materials can be derived from a vast array of solid elemental materials (metals like aluminum, silver and semiconductors like silicon or germanium) as well as compounds (aluminum oxide, silver iodide, silicon nitride, etc.). All of these materials have inherent optical, thermal, and mechanical properties which derive from their fundamental nature individually, as well as properties that result from their compounds. Aluminum, for example, is highly reflective whereas aluminum oxide is transparent. Additionally many of these materials can be designed to realize particular properties if they are combined and or structured in a particular fashion.

These so called engineered materials can be mixed to form a single new material with new properties, and/or they can be combined to create one dimensional, two dimensional, and three dimensional structures. A one-dimensional structure can be represented by a single thin film, a two-dimensional structure can be represented by single or multiple films which have a two dimensional pattern formed in them, and a three-dimensional structure has patterns with three dimensions. Two and three-dimensional structures can be produced using a wide array of nano and micro machining and patterning techniques which are well known by those skilled in the art. All of these dimensional forms may comprise one or more elemental or compound materials. Generally, these material structures have dimensions on the order of nanometers (so called nano-structured materials) and micrometers (so called micro machined materials). Examples of such materials are discussed in the following articles: Coherent Thermal Radiation in Thin Films and its Application in the Emissivity Design of Multilayer Films, Chinese Science Bulletin, May 2007, Vol. 52, No. 10, 1426-1431; Thermal Antenna Behavior for Thin Films Structures,Philippe Ben-Abdallah; Introduction to Photonic Crystals:Bloch's Theorem, Band Diagrams, and Gaps(But No Defects)Steven G. Johnson and J. D. Joannopoulos; and Solar Absorbing Ceramic/Glass Coatings Increasing the Efficiency of Environmentally Friendly Energy Production, Mark O. Naylor. Each of these articles are incorporated herein by reference. For the purposes of this application the term “engineered material” or derivatives thereof are intended to represent the range of materials and material combinations described above, whose form and composition have been designed to achieve a particular function.

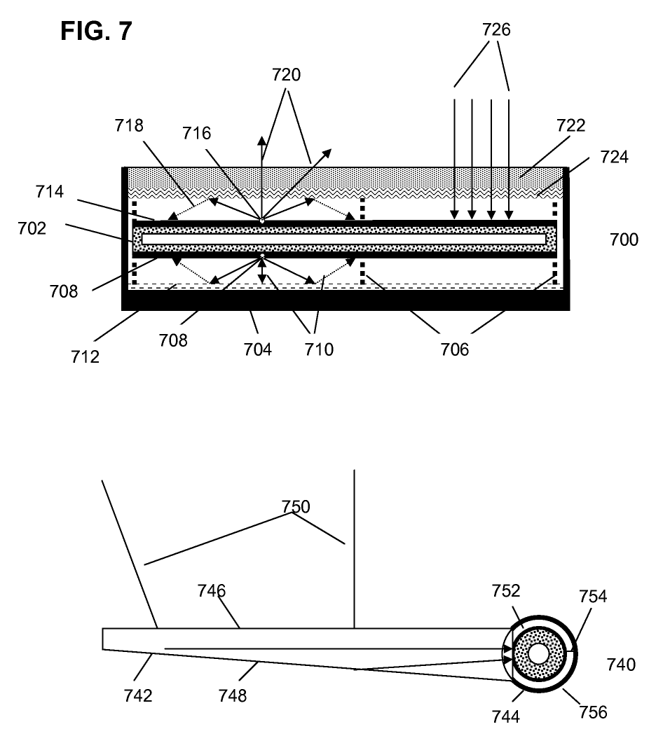

FIG. 7 illustrates an evacuated flat heat pipe solar array collector 700, and planar concentrator collector module 740. Heat pipe 702, is suspended via supports 706, within vacuum vessel 704. The collector further comprises solar window 722, which is a transparent material such as a glass, or a specially designed glass or plastic, which is substantially transparent to light from about 200 nm to 3 microns, corresponding roughly to the solar energy spectrum. Inner coating 724, is a thin film or combination of thin films with engineered optical properties.

The window may also incorporate coatings on its outer surface designed to minimize reflections from incident light 726. Coatings 714, and 708 are engineered materials, such as aluminum nitride, designed to be highly absorbing in the range of the solar spectrum, but having low emissivity. Back reflector 712, is an engineered material, such as gold, which is formed or deposited to reside on the inner back surface of the vacuum vessel. This material is designed to be highly reflective at least in the near infrared range extending from 2 microns and beyond into the mid infrared region or more. Supports 706 serve to maintain the structural integrity of the shell that must withstand the force of the atmosphere given that there is a vacuum inside. The supports are fabricated to have either high aspect ratios (small lateral dimensions), or be comprised of a material with low thermal conductivity/high transparency, or both. In one embodiment, the supports can be fabricated using micromachining techniques that, for example would allow for the fabrication of an array of supports such that the area of contact to the outer shell and the heat pipe is on the scale of 10's of microns.

Alternatively, in accordance with one embodiment, the supports may be in the form of an array of spacer balls, such as those used in the manufacture of liquid crystal displays, made from a transparent oxide. This option is interesting because the spherical nature of the balls enables surface contact area to become diminishingly small, possibly submicron depending on the surface finish of the coatings 714, 712, 718, and 724. Silicon dioxide is one possible support material as, aero gels, both of which have the additional characteristic that they can be micro machined. In either case, proper design of the supports would allow for conductive losses between the heat pipe and the shell to be reduced to less than 1 percent or less. This would be defined by a thermal conductive properties of the supports, and their total area of their physical contact with the two surfaces.

During operation sunlight 726, passes through window 722, where it is subsequently absorbed by coating 714. Most of the energy is converted into heat which is conducted to heat pipe 702. Some of the heat, however, is isotropically re-radiated in the form of infrared radiation. In one embodiment inner coating 724 can be enhanced to make it reflective to certain portions of the infrared spectrum. For example, the addition of a film of aluminum oxide less than several microns thick, would provide a reflective surface for re-radiated infrared striking it within a certain range of angles, because it refractive index is less than 1 at certain infrared frequencies. Representative radiation point 716, is one source of isotropic radiation. In the case of re-radiated rays 720, the infrared light passes through the coating and subsequently the glass because it is beyond the critical angle defined by the aluminum oxide coating. However re-radiated ray 718, falls within the critical angle and is thus reflected back to coating 714 where it is reabsorbed. In this fashion, some portion of the infrared which is re-radiated from the front surface may be recycled, increasing overall efficiency.

Back reflector 712 performs a similar function in that re-radiated infrared rays emitted by coating 708, are subsequently reflected back to be reabsorbed and converted into heat. Because back reflector 712 is a metal, in this case, all rays regardless of angle are reflected.

Planar concentrator collector module 740 provides a lower cost option to flat plate collector 700. In this case a planar concentrator 742 is optically coupled to linear collector 752. Planar concentrator 742 is comprised of a transparent material or materials such as acrylic or glass. It can take the form of a rectangular beveled sheet such that area of the front surface 746 approximates the exposed surface area of collector 700. Front surface 746 is flat, and designed to maximize the transmission of light 750, which is incident upon it. This may involve the application of anti-reflective coatings to front surface to improve transmission. Incident light 750 strikes back reflector 748 and is re-directed towards the linear collector 752. The light is re-directed by virtue of micro-optic structures which are molded or otherwise mounted on to the back surface of the concentrator 748. These structures may take the form of one or a combination of reflective, diffractive, or refractive optical structures made from the material of the concentrator itself, or another optically compatible material. The optics of the concentrator may also be configured to utilize total internal reflection (TIR) to facilitate propagation within the concentrator medium. The structure and function of the concentrator is similar to that of LCD backlights (which take light from a linear source and distribute it uniformly across a 2 dimensional area) and as such can be readily designed and manufactured by those skilled in the art. In this case, the concentrator operates to take light which is incident across the entire front surface, and concentrate it on the much smaller area of the linear collector 752. Linear collector is contained within a vacuum vessel 744, which supports a vacuum inside, and is transparent on at least the side facing the incoming light. Vacuum vessel 744 may be similar in design to vacuum vessel 704, possibly incorporating support 754, and back reflector 756. In this fashion the effective light gathering area of collector 700, can be achieved with a much smaller collector 752, by virtue of the light re-direction achieved by the concentrator 742. Since the concentrator may be fabricated from inexpensive materials, versus potentially more expensive materials comprising the collector, large effective collection areas can be achieved at reduced cost.

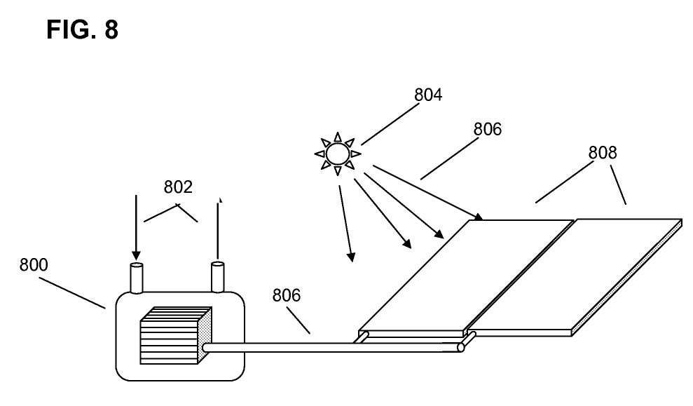

FIG. 8 illustrates a method of extracting heat from a solar collector array. A heat exchanger 800, like the one described in FIG. 4, is connected via heat pipe 806 which exchanges heated vapor and condensed fluid directly with the internal heat pipe of solar collector 808 to which it is connected via a vacuum seal. Alternatively heat pipe 806 is thermally joined to the internal heat pipe of the solar collector in the manner illustrated in FIG. 2 for joining heat pipes. Either configuration conveys heat much more efficiently than the use of the fluid flow transfer mechanism illustrated in FIG. 6. If the heat pipes are vacuum insulated then the losses from the system can become quite insignificant.

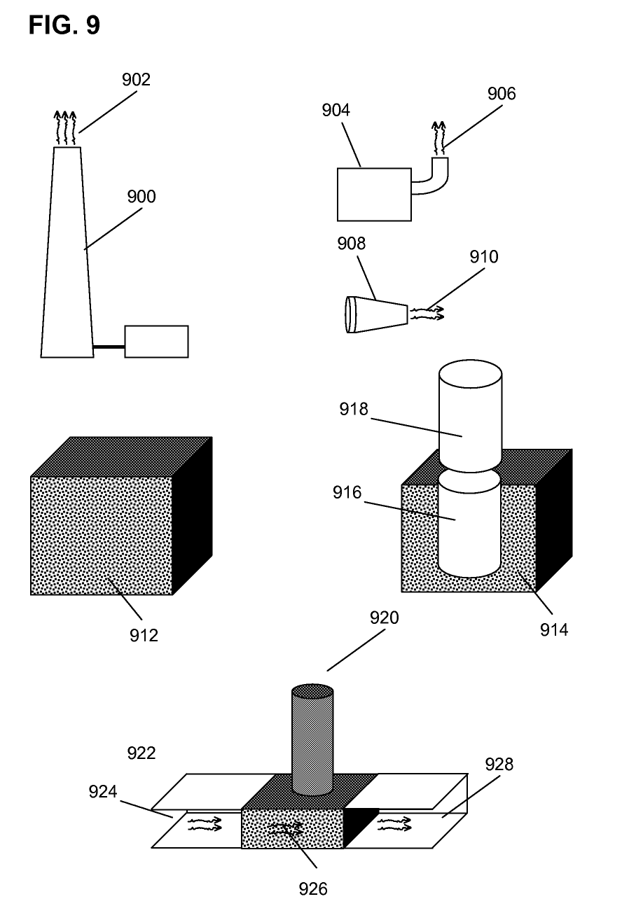

FIG. 9 shows combustion heat generators 900, 904, and 908 representing a power plant, an internal combustion engine, and a gas fired turbine respectively. Each source produces hot exhaust gasses 902, 906, and 910 whose temperature can achieve 1000's of degrees Fahrenheit. Metallic foam block made 912, is made from a metal like aluminum or copper, or perhaps graphite. Metallic foams can be made by a number of techniques which are well known by those skilled in the art. They are important because the dense internal pore structure creates large surface areas for a given volume.

Metallic foam block 914 has a heat pipe section 916 thermally embedded within it. Thermally embedding the heat pipe requires that the outer surface of the heat pipe be fused with the material of the metallic foam. One approach would be to coat the surface of the heat pipe with a compatible solder material, press fit the heat pipe into a pre-defined hole, and then raise the temperature of the entire assembly such that the solder melts and bonds the heat pipe surface with the metallic foam. One shortcoming of this approach is that the thickness of the shell a pre-fabricated heat pipe, say greater than 500 microns, will inhibit heat flow to the metallic foam. Press fitting and soldering would not be an appropriate integration technique for tubes with such thin walls. Another option would be to plate or deposit (perhaps via a sputtering process) a liner film inside the pre-defined hole to a thickness less than 500 microns, but sufficient to create a seamless inner film which prevents the permeation of gasses or liquids. An external heat pipe section 918 can then be bonded using solder, welding, or other robust technique to provide an impermeable join. In this fashion, heat transfer between the heat pipe and the metallic foam is significantly enhanced improving efficiency and reducing size.

Convection heat exchanger 922, is designed to extract energy from hot exhaust gasses. Hot exhaust gasses 924, are forced through foam block 926, and exit the vent at 928. The extremely high surface area of the block allows for improved efficiency of heat extraction from the exhaust gasses, heat is transferred to heat pipe 920 which can then be utilized elsewhere. Alternatively, a cool gas flow can be pumped through the heat exchanger and used to provide heat rejection that is coupled to the appropriate component via the heat pipe 920. Under certain circumstances it may be possible and advantageous to utilize the heat fin block design illustrated in FIG. 4, in lieu of a metallic foam construct for transferring heat.

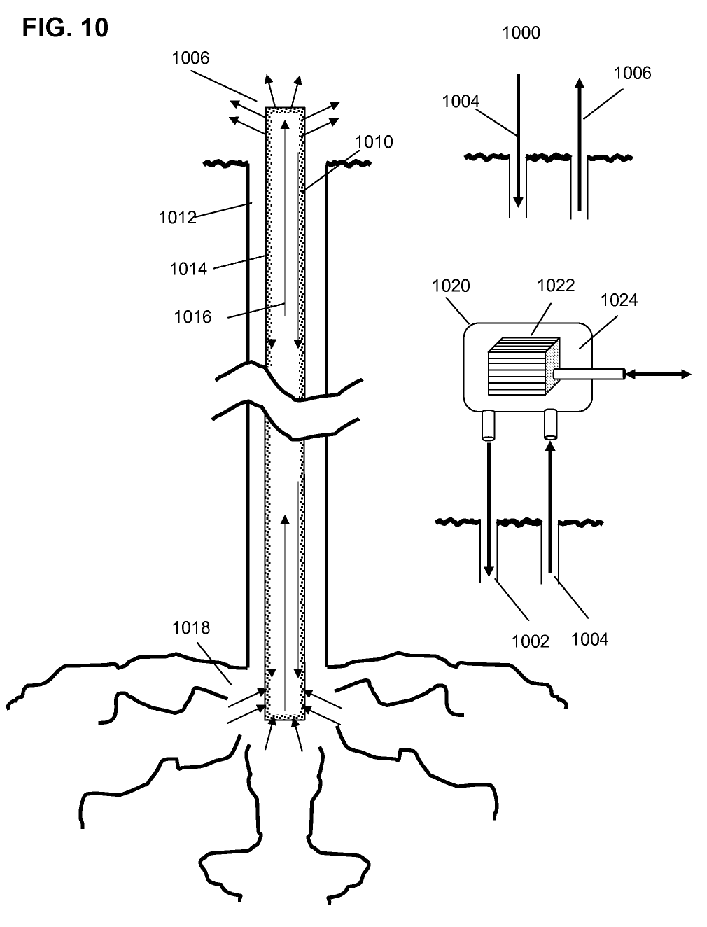

FIG. 10 shows a conventional geofluids loop installation 1000 in which geothermal fluid 1006 is pumped from the ground, and after heat is extracted the cooled fluid is pumped back into the ground 1004. This is complicated because it is not easy to determine appropriate re-injection well sites, and drilling the re-injection well adds additional costs. A heat pipe 1014 could be used instead if it were embedded in well 1012. It behaves like the classical heat pipe in that heat 1006, is extracted from heated vapor 1016 which rises upwards while condensed fluid 1014 flows to the bottom of the heat pipe to be re-heated in reservoir 1018. No re-injection is required and the nature of the heat transfer vapor/fluid is controlled. Because circulation of the geo-fluid must now occur underground, heat transfer rates may lower, but depending on the nature of the reservoir it may be possible to create circulation zones near the bottom of the well which can increase heat transfer rates.

Use of a heat pipe to extract heat from a geo-fluid brings other benefits as well. These concern minimizing the thermodynamic losses which occur when trying to extract heat from the geo-fluid, whose temperature is dropping during heat extraction, and the working fluid whose temperature may not change depending on where in the thermodynamic cycle the heat is being added. In the situation where the working fluid has been heated to its boiling point and additional heat serves to evaporate the working fluid, its temperature remains the same. However, as the geo-fluid losses heat, its temperature goes down. This changing difference in temperature reduces the efficiency of the heat transfer. Heat pipe heat exchanger 1020, can bring two enhancements to this process.

Heat fin block 1022, is immersed in the geo-fluid 1024, which is extracted from the ground 1004, and subsequently re-injected, 1002. The design as described in FIG. 4 will help minimize temperature differences between the heat fin block surface and the geo-fluid. Appropriate design of the geometry of the heat fin block can allow it to improve the match between the thermal gradient of the geo-fluid as it passes through the heat exchanger 1004, and the heat fin block temperature. In particular varying some combination of external surface area, the internal volume, or the internal gas-flow characteristics of the heat fin block, possibly along the axis of the flow of the geo-fluid, can provide a robust means for minimizing the temperature differential between the geo-fluid and the heat block surface.

The second enhancement occurs on the working fluid side of the heat exchanger. In this case the isothermal nature of the heat pipe, i.e. its tendency to suppress temperature difference on its surface, will present a uniform heat transfer surface to the working fluid 1024, which will be at a constant temperature as it evaporates. This can further reduce thermal losses during heat transfer.

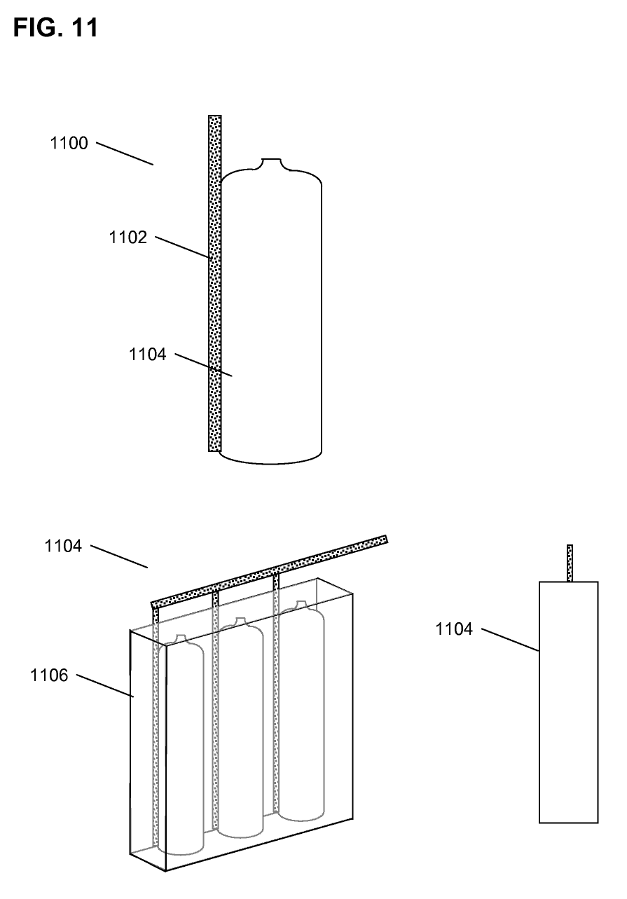

A thermal storage system is shown in FIG. 11. An off the shelf pressurized fluid/gas storage tank 1104 (such as those used for compressed natural gas) is filled with water. Other thermal storage mediums which could be used instead of water include but are not limited to paraffin, certain salt hydrate solutions, and metal hydride materials. The tanks can be designed to handle pressures as high as 6000 psi though only about 3000 psi is required for the temperature maximums of interest (about 250 deg C.). Heat pipe 1102 is thermally bonded to the wall, therefore providing a means for injecting or extracting heat. An array of such tanks is suspended in a vacuum cabinet 1106 to provide thermal isolation. The inner surface of the vacuum cabinet may be of gold foil or any other IR reflecting engineered material. The number and size of tanks is dictated by required size of storage and rate at which heat must be injected or extracted.

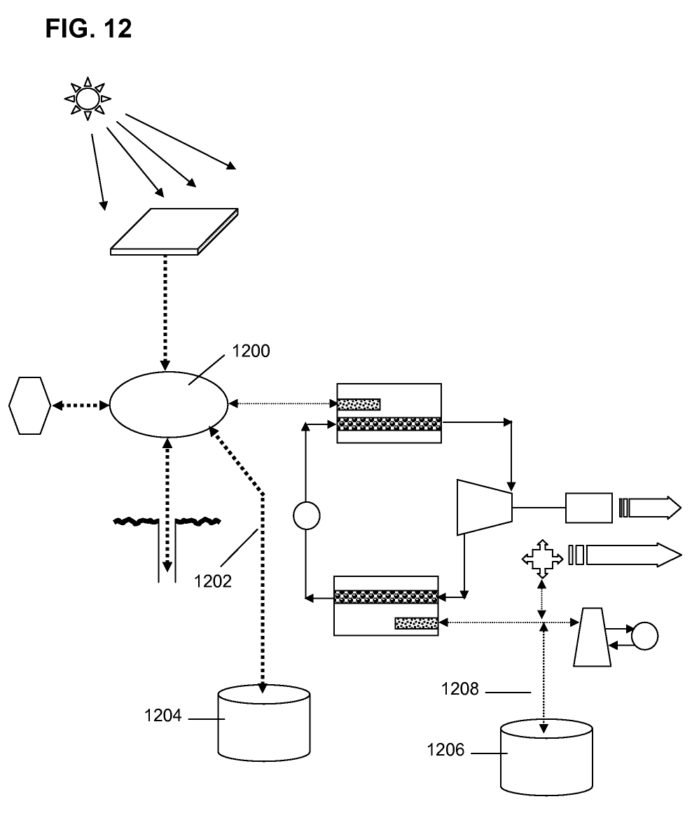

Heat pipe based interface improvements described in FIGS. 7-11 allow for enhancements in the heat engine system shown in FIG. 12. Connections 1202, between generic heat source 1200 (i.e. any heat source) and storage 1204 are now based on heat pipes, eliminating pumping losses external to the Rankine Cycle, and improving efficiency. Also shown is heat sink thermal storage 1206 which is connected to the system 1210 via heat pipe 1208. The purpose of this unit is to supplement the function of heat rejector 1210 during operation of the system. In the embodiment where heat rejector 1210 is of the passive radiator type, the efficiency of heat rejection will generally be higher at night as there will be less infrared radiation emanating from the sky. Thus, there exists the potential to store heat rejection potential in the form of a cooled storage medium, for use during the day when radiative heat rejection becomes less efficient. This storage unit is essentially identical to the one described in FIG. 11 though the storage medium may differ in that it is optimized for a lower temperature range, perhaps as low as the freezing point of water or lower.

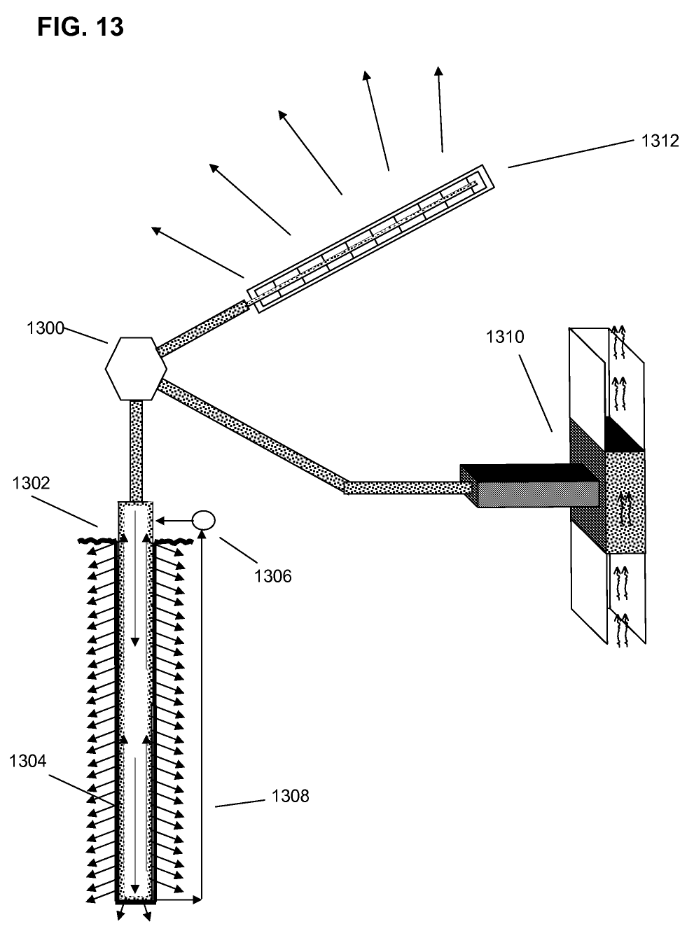

FIG. 13 illustrates that heat rejection can be accomplished through various means including but not limited to conduction into the ground, convection into an ambient gas stream, and radiation to the sky using variations on components described earlier. In this example, generic rejected heat source 1300, is shown coupled via heat pipe to ground heat rejectors 1302, air heat rejector 1310, and radiative heat rejector 1312. Ground heat rejector 1302 is shown with an external liquid pumping loop 1308, driven by pump 1306 which may be required because of the necessary bore hole lengths.

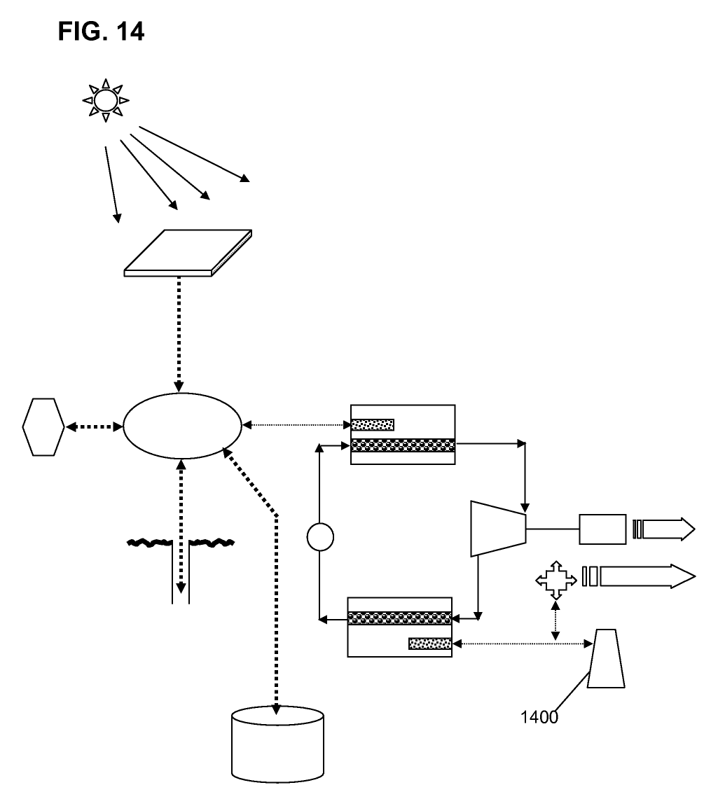

Referring now to FIG. 14, heat rejector 1400 no longer has a pump associated with it, as a result of the improvements described in FIG. 13. This further reduces overall system parasitic losses.

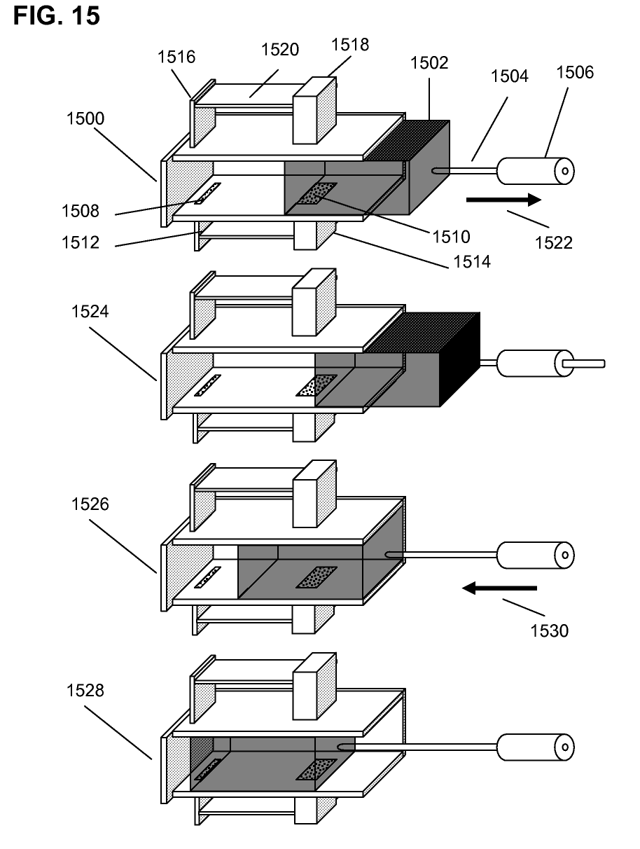

FIG. 15 portrays schematically a variation of a steam heat engine in four states. The engine is similar in design to that of Stirling engines which are a class of external heat engines which receive heat from a source outside the engine, and use working fluid (a gas) which is sealed inside to act on a movable member. These engines, and their many variations, are well known in thermodynamics and usually transfer power by the action of the working fluid against a piston. While theoretically capable of achieving the idealized Carnot efficiency, their performance is hampered by several factors, principle among them the limitations on transferring heat to the working fluid, and the viscous flow losses caused by the movement of the displacer, a feature of most designs.

The heat engine of FIG. 15 comprises a rectangular housing 1500 (shown in cutaway) which contains a piston 1502. The housing is rectangular for illustration purposes only and cylindrical or other geometric configurations are equally viable. The piston is sized to form an airtight and low friction seal against the internal walls of the housing. Heat pipe source aperture 1508 and sink aperture 1510, are shown on one internal wall of the housing and, while not visible in this drawing, reside internally on the facing wall as well, though this may not be necessary. Other designs could utilize all four wall surfaces, or the entire inner circular section of a cylinder.

Heat source wick, 1512 is open to the engine housing interior via heat pipe aperture 1508, and heat sink wick 1514, is open to engine housing interior via heat pipe aperture 1510. Open means that gaseous transport may occur between the respective wicks and the interior of the engine, while a vacuum seal is still maintained between the engine and its environment. On the exposed side of the facing wall, a capillary section 1520, is shown connecting the non-visible but physically equivalent heat source/sink wicks on the facing wall. The sink aperture and associated wick are both larger in aperture area and total wick surface area than that of the source aperture and wick. The housing and piston, as mentioned, are sealed. The sealed volume comprising the housing, the heat source and sink wicks, and the respective capillary sections are filled with a working fluid in the same fashion as a conventional heat pipe. That is the entire volume is filled with the working fluid in a gaseous form at a partial vacuum near the vapor pressure causing some of the fluid to exist in vapor form and some in liquid form.

In normal operation, most if not all of the liquid phase of the working fluid resides in the capillary and wick sections. Heat is applied to heat source wicks, 1516 and 1512, causing the liquid to evaporate, and produce a vapor stream from the source apertures. This expanding vapor applies pressure to the piston causing it to displace in the direction indicated by arrow 1522. The piston may act against a restraining or biasing force in the form of a spring, external atmospheric pressure. In another embodiment the restraining force could be in the form of an identical heat engine, mounted in this case to the right of the illustrated engine so that it works 180 degrees out of phase. As the piston is further displaced by the addition of vapor from the source aperture, its movement eventually exposes the sink apertures, aperture 1510 being visible.

Sink aperture 1510, is thermally coupled to a heat sink, thus providing a means for condensing the vapor within the heat engine's housing. Because of the seal between the piston and the housing this condensation can only begin after the piston's displacement has begun to expose the sink aperture. Due to the high source aperture area and/or source wick surface area, condensation can occur at a much faster rate than evaporation. With proper design this can allow for the majority of the gas within the housing to be removed by the time the piston reaches its maximum displacement shown in 1524.

The resulting increased partial vacuum allows the restraining force to displace the piston in the opposite direction, shown in 1526, direction indicated by arrow 1530. With proper design of the engine, working fluid vapor, which is continually produced by the source aperture, provides sufficient pressure to help stop the displacement, shown in 1528, and begin the cycle again.

The piston is connected to a rod 1504 that acts as a rotor of a linear alternator, the stator of which is illustrated by 1506. As a consequence, oscillatory motion of the piston or mechanical work, can be converted into electricity by the interaction of the fields within the alternator.

Overall the engine is essentially a heat pipe with an external capillary condensate liquid return section, a source aperture and wick structure for the injection of working fluid vapor, and an expanded sink aperture and wick structure to provide for rapid extraction of the vapor. This design offers two enhancements over most Stirling engine designs. Firstly, it significantly improves the transfer of heat into the working fluid since this is accomplished by evolving a vapor at or near the point where the heat source resides, thus heat is transferred via conduction (into a liquid which subsequently evaporates) vs. convection which is the case with most gas based Stirling engines. The second enhancement is the elimination of the displacer. This is a piston like element which serves to push the gas, in a conventional Stirling engine, from the hot side of the cylinder to the cold side. The resulting viscous flow losses degrade efficiency, but are not resident in this design.

Furthermore, since the capillary section serves to naturally pump the fluid from the sink wick to the source wick, there are no additional parasitic losses due to pumping of fluids. One possible design feature of this engine is a means to provide thermal insulation between the heat sink and sink aperture and the housing, while allowing some portion of the heat from the heat source to conduct to the walls. In this way the housing is maintained at a temperature that precludes condensation on the internal walls, a factor that might create friction between the housing and the piston. Conversely, alternative designs may thermally decouple the heat source from the housing and couple the heat sink to the housing. This could produce a film of condensation that, for some designs, could act as a seal and provide a fluid bearing between the housing and piston thus reducing friction. The working fluid selection, as it is in a conventional heat pipe, is determined by the operational temperature range as well as the thermo-physical properties of the working fluid.

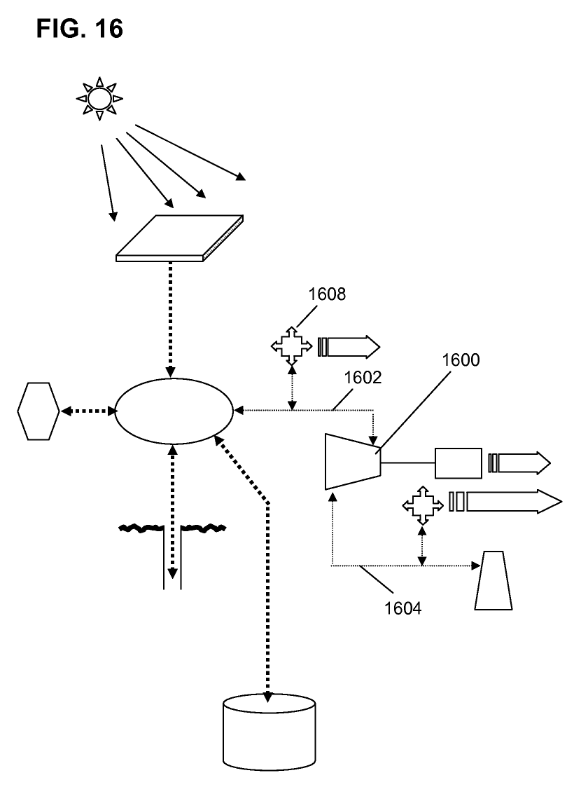

Referring now to FIG. 16, the final source of parasitic losses in the heat engine system has been removed. In this case the pumping losses originally required to circulate working fluids around the turbine, 1600, have been eliminated by replacing the turbine with the heat engine described in FIG. 15. Heat is supplied to the engine via heat pipe 1602, and rejected via heat pipe 1604. Optional hot water supply 1608, is also shown driven by heat from heat pipe 1602.

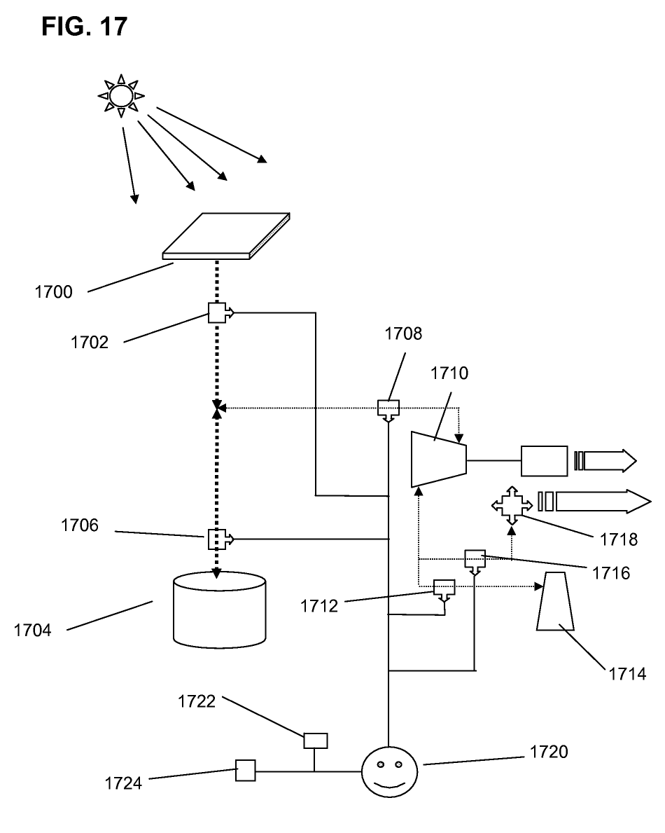

FIG. 17 illustrates a solar driven heat engine system with a control system 1720, a microprocessor based system, which regulates thermal monitor/modulators 1702, 1706, 1708, 1712, 1716. These modulators direct the flow of heat within the system and are some variation of a modulatable heat pipe. They also contain temperature sensors allowing for assessment of the thermal state of the heat pipes and the components which they connect. Local sensors 1722 can provide information about the local solar and weather conditions to the control interface 1720. Software residing on control system 1720, can allow for autonomous operation based on environmental inputs to the system (energy, heat rejection, system characteristics, etc.) user demands and taste. Sensors allow for enhanced response to changing solar flux conditions. Control interface 1724, which can connect to networks such as the internet, cellular, or other communications networks, allows for local monitoring and diagnostics of a single system, and remote monitoring, diagnostics, and control of a network of such installations. A network of such installations can be the basis for a distributed power generation network.

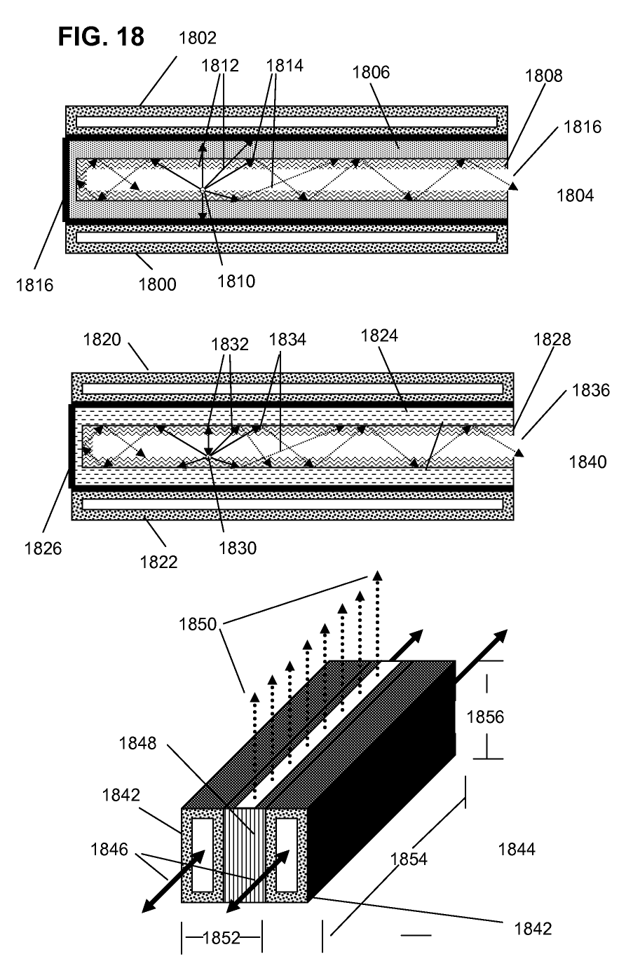

FIG. 18 illustrates two versions of a radiative waveguide 1804, and 1840 shown in cross-section. Radiative waveguide 1804, comprises metallic housing 1816, which is bonded on two sides to planar heat pipes 1802 and 1800, in a way which allows for heat transfer via conduction between the heat pipes and the waveguide. The internal surface of the housing 1816, of waveguide 1804, has reflective layer 1806 which comprises an engineered material. The housing maybe of a variety of materials though in general it should have a high thermal conductivity, and must be able to support an optically smooth surface on its interior.

Copper is one example though aluminum or other materials could function as well. In one embodiment layer 1806 may consist of an engineered material whose optical characteristics are such that they possess a refractive index lower than 1 in some desired portion of wavelength ranges extending outside the visible range into the infrared region, generally speaking beyond 700 nanometers. Aluminum oxide and silicon dioxide are two such materials that exhibit refractive indices <1 at certain wavelength region longer than 4 microns. Deposited on the surface of reflective layer 1806, is an optional radiative launch layer 1808, which again may comprise an engineered material of single or multiple layers of oxide films. One characteristic of this layer is that it have an emissivity greater than that of reflective layer 1806, and that it not substantially attenuate infrared radiation which propagates through it. Another characteristic the launch layer is that its emissive properties can be designed to encourage radiation in specific wavelength regions, for example, the range of 8 microns to 13 microns. This range coincides with the atmospheric window, a range of wavelengths which are not substantially attenuated by the earth's atmosphere, thus enhancing the radiative performance. The interior of the waveguide is maintained at a vacuum.

During operation, heat from heat pipes 1802 and 1800 is thermally conducted through the housing through reflective layer 1806, and subsequently to launch layer 1808. As a consequence both reflective layer 1806, and launch layer 1808 will emit thermal radiation according to the laws of thermodynamics though the launch layer, because of its higher emissivity, will emit more radiation. This emitted radiation will be emitted from the surface isotropically i.e. in all directions from all points on the surface of the launch layer. A representative emission point 1810, is shown for purposes of illustration. Because the launch layer has an index of less than 1 at certain wavelength ranges, radiation that emerges outside the critical angle range can undergo total internal reflection. Thus, the reflective layer acts in the similar fashion as the cladding in a hollow core optical fiber or waveguide in this case. For example rays 1812 are shown propagating from emission point 1810 at an angle within that of the critical angle range. As a consequence they propagate though to the housing where they are partially absorbed, thus heating the housing, and partially reflected. Emitted rays 1814, have been emitted in outside the critical angle range. As a result they will propagate within the waveguide under the principles of TIR until they exit the waveguide at the exit aperture 1816.

Waveguide 1840 is identical in every way to waveguide 1804 except in the nature of its reflective film 1824. In this case the reflective film comprises an engineered material whose refractive index greater than 1, and whose reflectivity is designed to be very high, greater than 90%, in the infrared regions of interest. It is also designed to have a lower emissivity than that of the launch layer 1828. In one embodiment gold, or a combination silver/silver iodide films less than a micron thick can achieve this goal. Radiation from launch layer 1828 is also emitted isotropically and is another engineered material like that of launch layer 1808. Relevant emission point 1830 is the source of rays 1832, and 1834. Because the principles of TIR do not apply in this case, reflection occurs at all angles in a specular fashion. Since the reflective layer 1824 is not perfect, some portion of the radiation incident on its surface is absorbed and converted into heat. However some portion of the radiation propagates inside the waveguide where it is ultimately emitted at exit aperture 1836.

Both waveguides provide a means for extracting heat from a heat pipe and rejecting it in the form of radiation via the exit aperture. In the case of waveguide 1816, while propagation is virtually lossless, less radiation is coupled into the waveguide because TIR only works over a certain range of angles. In the case of waveguide 1826, coupling of the emitted radiation is more efficient, but the losses during propagation are going to be larger because the reflector is not lossless. The selection of one design over the other will depend on the nature of the specific application, long waveguides vs. short for example, the wavelength of the radiation to be emitted, and the ease of manufacture as dictated by the different choice of materials.

Radiative waveguide component 1844, is shown in perspective view and can utilize either waveguide configuration. As shown in this Figure, heat carried by heat pipe working fluid 1846, is propagated within the heat pipes 1842, conducted into waveguide 1848, where it is emitted as infrared radiation 1850. Using appropriate manufacturing techniques the width 1852, of the waveguide component can be as small as 3 millimeters (mm) or less.

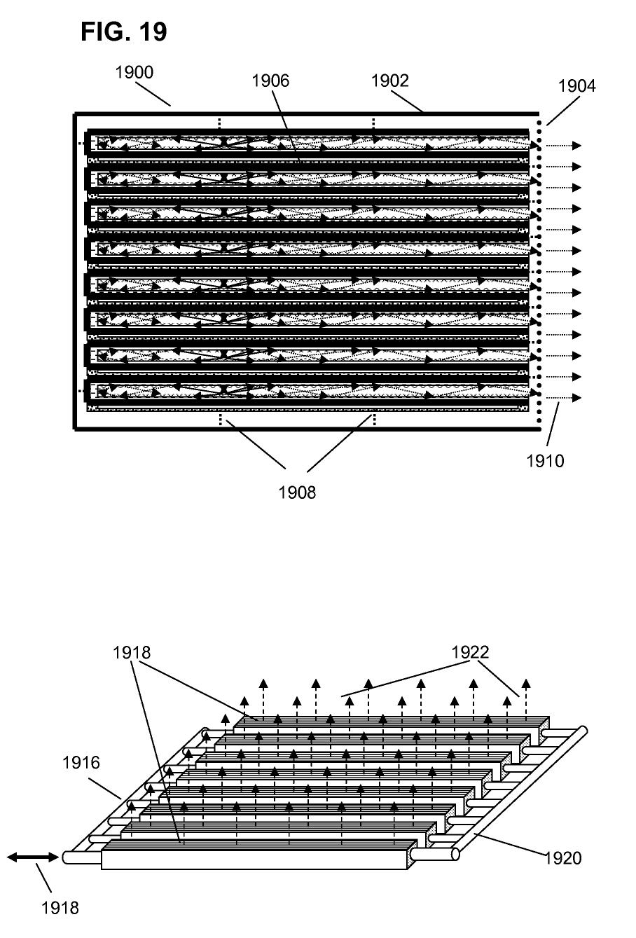

FIG. 19 reveals a cross-section of a radiative waveguide array 1900. It comprises a thermally isolating vacuum sealed vessel 1902, which is bounded on one side by an infrared window 1904. The housing may consist of any number of materials, metals, glass, or coated plastics for example, as long at is capable of maintaining a vacuum against atmosphere and the elements, and as long as internal surfaces can be designed coated in such a way as they will reflect infrared radiation internally. Infrared window 1904, can comprise infrared transmitting glass, plastic, or other materials that can maintain a vacuum, and exhibit high transmission in the wavelength region of interest. Radiative waveguide array 1906, is comprised of a number of radiative waveguide components which have been physically bonded together such that they are in thermal contact. In addition, all of the associated heat pipes are connected to a common internal heat pipe buss, (not shown) which allows for exchange with an external heat source. Supports 1908, serve to provide a physical means of mounting and suspending the array inside housing 1902, in a way that minimizes thermal conduction from the housing to the array.

This diagram illustrates a means by which the heat propagating through the associated heat pipes may be radiated from a relative small space. Referring again to FIG. 18, if the width 1852 is 2 mm, the length 1854 10 cm, and the height 1856 10 cm, then combining 50 waveguide radiators 1844, would produce an array approximately 10 cm×10 cm×10 cm. This array, however, would have an effective radiative surface area of 0.5 sq meters. This will result in device with radiative power gains of over that of a single flat plate radiator with dimensions 10 cm×10 cm.

While the foregoing is directed to embodiments of the present invention, other and further embodiments of the invention may be devised without departing from the basic scope thereof, and the scope thereof is determined by the claims that follow.

What is claimed is:

1. A method for harnessing a heat source to produce energy, comprising:
transferring heat from the heat source to a working fluid using at least one heat pipe; and
performing work via the heated working fluid.

2. The method of claim 1, further comprising using a plurality of heat pipes to transfer the heat.

3. The method of claim 2, further comprising modulating the transfer of heat in each heat pipe.

4. The method of claim 3, wherein modulating the transfer of heat in each heat pipe comprises controlling an operating characteristic of the heat pipe.

5. The method of claim 4, wherein the operating characteristic comprises an internal volume of the heat pipe.

6. The method of claim 1, wherein performing the work comprises driving a piston from a first position to a second position.

7. The method of claim 6, further comprising biasing the piston towards the first position.

8. A method for harnessing a heat source to produce energy, comprising:
operating a thermodynamic cycle to convert heat into work, comprising displacing a working fluid within a closed loop, said closed loop being defined by a first pathway within a working chamber, and a return pathway external to the return chamber; wherein displacement of the working fluid along the first pathway causes sympathetic displaced of a movable member held captive in the working chamber, and displacement of the working fluid along the external pathway is under influence of capillary forces; and
transferring heat to the working fluid using at least one first heat pipe.

9. The method of claim 8, wherein the thermodynamic cycle comprises a Rankine cycle or a derivative thereof.

10. The method of claim 8, further comprising cooling the working fluid by removing heat therefrom using at least one second heat pipe coupled to a heat sink.

11. The method of claim 10, further comprising controlling the flow of heat in the first and second heat pipes by changing an operating characteristic of said pipes.

12. A method for harnessing a heat source to produce energy, comprising:
operating a thermodynamic cycle in which a working fluid is circulated within a closed loop to perform work; and
exchanging heat with the working fluid using modulatable heat pipes.

13. The method of claim 12, wherein the work comprises linear displacement of a piston within a chamber.

14. The method of claim 13, wherein a vapor phase of the working fluid travels from a heated end of the chamber to an end remote therefrom, and returns to the heated end via an external path using a pump.

15. A system for producing energy from a heat source, comprising:
a heat engine; and
at least one heat pipe coupled to the heat engine to exchange heat with a working fluid of the heat engine.

16. The system of claim 15, wherein a rate of heat transfer in the at least one heat pipe can be modulated by changing an operating characteristic of the heat pipe.

17. The system of claim 15, wherein a liquid phase of the working fluid is displaced under influence of capillary forces.

18. A heat engine system, comprising:
a heat engine, comprising a working fluid circulating within a closed loop;
at least one heat exchange device comprising a two-phase heat transfer fluid; and
a control unit to control operation of the heat exchange device.

19. The heat engine system of claim 18, wherein the control unit controls an internal volume of the heat exchange device.

20. The heat engine system of claim 18, wherein the control unit controls a flow rate for a vapor phase of the heat transfer fluid.
